(19) United States
(12) Patent Application Publication
(10) Pub. No.: US 2006/0075247 A1
(43) Pub. Date: Apr. 6, 2006

(54) System and method for establishing an authenticated timestamp and content certification

(75) Inventor: Mark Liu Stevens, Laguna Hills, CA (US)

Correspondence Address: SHARP LABORATORIES OF AMERICA, INC, 5750 NW PACIFIC RIM BLVD, CAMAS, WA, 98642, US

(73) Assignee: Sharp Laboratories of America, Inc.

(21) Appl. No.: 10/951,455

(22) Filed: Sep. 27, 2004

(51) Int. Cl. H04L 9/00

(52) U.S. Cl. 713/178

(57) ABSTRACT

A digital signature containing a timestamp from when a digital document is generated is attached to the digital document. Timestamp information is obtained from a time source that is traceable to a time standard, such as a Network Time Protocol (NTP) server, a National Institute of Standards and Technology (NIST) time server or a radio broadcast station. The timestamp information is encrypted using a private key of a public/private key pair and attached to the digital document as the digital signature.

### BACKGROUND OF THE INVENTION

1. Field of the Invention

The present invention generally relates to authentication of digital copies of documents. More particularly, the present invention relates to a system and method for enhancing authentication of documents that that been processed using a digital scanner, a printer, a facsimile machine, a copier, a multifunctional peripheral (MFP) device, a digital camera, a mobile telephone having a digital camera and/or a personal computer (PC).

2. Description of the Related Art

A digital, or electronic, copy of a document that has been scanned by a copier is often used to archive the original document. A verifiable time and date that the original document existed cannot be conventionally authenticated merely by the existence of a digital copy of the document. Additionally, a digital copy of a document could be subsequently altered and passed off as unaltered. Further, it could be asserted that a digital copy of a document existed prior to the creation of the original document and/or the digital copy of the document as proof that the document existed at a time that was earlier than is really the case.

What is needed is a technique to attach a timestamp that is traceable to a time standard to a digital copy of a document. Additionally, what is needed is a technique for attaching a timestamp that is traceable to a time standard to a digital document.

### SUMMARY OF THE INVENTION

The present invention provides a technique to attach a timestamp that is traceable to a time standard to a digital copy of a document. The present invention provides a technique for attaching a timestamp that is traceable to a time standard to a digital document.

The advantages of the present invention are provided by a system for associating a timestamp with a digital document that includes a digital document generator and a digital signal generator. The digital document generator generates a digital document, which can be digital copy of a document, such as a TIFF-formatted digital copy, or a PDF-formatted digital copy, or a digital document, such as a digital image-based document or an electronically editable document. The digital signature generator generates a digital signature for the digital document by encrypting a time obtained from a time source with a private key of a public/private key pair. The time is obtained from the time source when the digital document is generated. According to the present invention, the time source can be, for example, a Network Time Protocol (NTP) server, a National Institute of Standards and Technology (NIST) time server or a radio broadcast station that is traceable to a time standard. When the digital document is a TIFF-formatted digital document, the digital signature generator attaches the digital signature to the digital document of the document as a tag. When the digital document is a PDF-formatted digital document, the digital signature generator attaches the digital signature to the digital document as a property of the digital document. The digital signature generator can also attach a public key of the public/private key pair to the digital document.

In one exemplary embodiment, a cyclic redundancy check generator generates a cyclic redundancy check value for the digital document, and the digital signature generator generates the digital signature by encrypting the time obtained from the time source and the cyclic redundancy check value with the private key. In another exemplary embodiment, a one-way hash function generator generates a one-way hash function for the digital document, and the digital signature generator generates the digital signature by encrypting the time obtained from the time source and the one-way hash function with the private key.

The present invention also provides a method for associating a timestamp with a digital document, which can be a digital copy of a document, such as a TIFF-formatted digital copy or a PDF-formatted digital copy, or a digital document, such as a digital image-based document or an electronically editable document. A time is obtained from a time source that is traceable to a time standard when the digital document is generated, and a digital signature is generated for the digital document by encrypting the time obtained from the time source with a private key of a public/private key pair. The time can be obtained from, for example, a Network Time Protocol (NTP) server over a telecommunications network, a National Institute of Standards and Technology (NIST) time server over a telecommunications network and/or a radio broadcast station. The digital signature is decrypted using a public key of the public/private key pair.

When the digital document is a TIFF-formatted file, the digital signature is attached to the digital document as a tag. When the digital document is a PDF-formatted file, the digital signature is attached to the digital document as a property of the digital document.

When a cyclic redundancy check value is generated for the digital document, generating the digital signature includes encrypting the time obtained from the time source and the cyclic redundancy check value with the private key. When a one-way hash function for the digital document, generating the digital signature includes encrypting the time obtained from the time source and the one-way hash function with the private key.

### BRIEF DESCRIPTION OF THE DRAWINGS

The present invention is illustrated by way of example and not by limitation in the accompanying figures in which like reference numerals indicate similar elements and in which:

FIG. 1 is a functional block diagram of an exemplary system according to the present invention for attaching a timestamp to a digital document in which the timestamp is traceable to a time standard;

FIG. 2 shows a flow diagram of a method according to the present invention for attaching a timestamp to a digital document in which the timestamp is traceable to a time standard; and

FIG. 3 shows a flow diagram of a method according to the present invention verifying the time of existence of a digital document.

### DETAILED DESCRIPTION OF THE INVENTION

The present invention generates a digital document and attaches a timestamp that is traceable to a time standard, or time reference, that can be used for authenticating the time that the digital document was generated and for authenticating the contents of the digital document. Accordingly, the present invention provides proof that a document existed at the time indicated by the timestamp that is attached to the digital document. It should be understood that a “digital document,” as the term is used herein, could be a digital copy of a document, a digital image-based document and/or an electronically editable document.

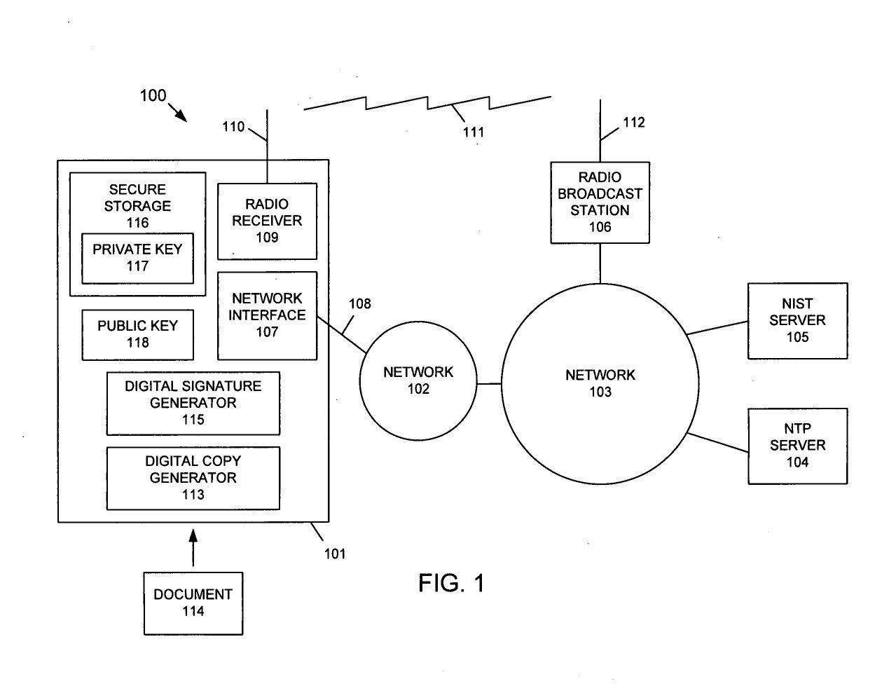

FIG. 1 is a functional block diagram of an exemplary system 100 according to the present invention for attaching a timestamp to a digital document or a digital image in which the timestamp is traceable to a time standard. System 100 includes a digital scanner 101 that is coupled to a first telecommunications network 102. First network 102 is coupled to a second telecommunications network 103. A Network Time Protocol (NTP) server 104 and a National Institute of Standards and Technology (NIST) time server 105 are coupled to second telecommunications network 103. A low-frequency radio broadcast station 106 is also coupled to second telecommunications network 103.

It should be understood that digital scanner 101 could also be a printer, a facsimile machine, a copier, a multifunctional peripheral (MFP) device, a digital camera, a mobile telephone having a digital camera and/or a personal computer (PC) having scanning capabilities and/or the capability to generate a digital, or electronic, copy of a document, such as by generating, for example, a document to a TIFF-type format and/or a PDF-type format and/or the capability of generating a digital image. It should also be understood that the digital document could also be an electronically editable document that has been generated by, for example, a word processor, a text editor, and/or an image editor application. Additionally, first telecommunications network 102 could be, for example, a Local Area Network (LAN), a Wide Area Network (WAN), a Wireless LAN (WLAN), and/or the Internet. Similarly, second telecommunications network 103 could be a LAN, a WAN, a WLAN, and/or the Internet. It should also be understood that system 100 could be configured with only one telecommunications network. It should be further understood that a plurality of NTP servers 104 and/or a plurality of NIST time servers 105 could be connected to either first telecommunications network 102 and/or second telecommunications network 103. It should also be understood that radio broadcast station 106 might not be coupled to either first telecommunications network 102 or second telecommunications network 103 and that there could be a plurality of radio broadcast stations 106 operating at the same or at different broadcast frequencies.

Scanner 101 includes a network interface 107 that is coupled in a well-known manner to first telecommunications network 102 through a network connection 108. Alternatively or additionally, scanner 101 includes a radio receiver 109 and an antenna 110 that is configured to receive radio transmissions (radio link) 111 that are broadcast from an antenna 112 of radio broadcast station 106. Scanner 101 also includes a digital copy generator 113 for receiving a document 114 that is to be scanned, a digital signature generator 115, and a secure storage 116 that contains a private key 117 of a public/private (asymmetric) key pair, such as a PGP or similar type public/private key pair. It should be understood that all public-key-type algorithms are suitable for use with the present invention. Digital signature generator 115 can be embodied as, for example, a digital signal processor that executes an encryption algorithm. Secure storage 116 must be configured so that there is no unauthorized access to private key 117. A public key 118 of the public/private key pair is also stored in scanner 101, but does not need to be stored within secure storage 116 because access to public key 118 is required in order to verify a timestamp and/or authenticate the contents of a digital copy of a document. Measures should be taken so that private key 117 and/or public key 118 cannot be altered.

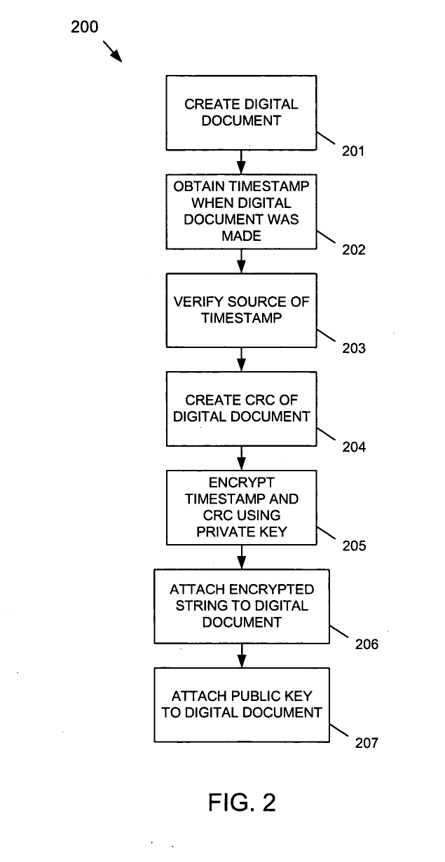

FIG. 2 shows a flow diagram 200 of a method according to the present invention for attaching a timestamp to a digital document in which the timestamp is traceable to a time standard. At step 201, digital scanner 101 scans document 114 and digital copy generator 113 generates a digital, or electronic, copy of the document in a well-known manner. At step 202, when a digital document is generated, digital scanner 101 obtains a timestamp from a time standard source, such as from a NTP server 104 and/or an NIST time server 105 through network connection 108, and/or from radio broadcast station 106 via radio link 111. Each NTP server 104, NIST time server 105 and radio broadcast station 106 provides timestamp information that is traceable to a recognized time standard. Alternatively, when scanner 101 is coupled to a LAN, scanner 101 could obtain timestamp information from a resource that is coupled to the same LAN and that receives timestamp information from a traceable time standard.

When digital scanner 101 receives timestamp information over a telecommunications network, such as the Internet, scanner 101 uses, for example, a tracert command for identifying the path through the telecommunication network to the source of the timestamp information. More specifically, at step 203, when digital scanner 101 sends a request to a time standard server (i.e., NTP server 104 or NIST server 105), digital scanner 101 also sends a tracert command having the IP address of the time standard server as a parameter. The tracert command provides route and time information for the request in a well-known manner. The route and time information received from the tracert command is then incorporated by digital scanner 101 into the timestamp information that is attached to the digital document. The route information received in response to the tracert command can be used as a verification that digital scanner 101 was not spoofed by a false time source. Additionally or in the alternative, the digital certificate of the time source can be incorporated into the timestamp information that is attached to the digital copy of the document. When digital scanner 101 cannot verify the authenticity of the current time, such as by using the digital certificate of the time source, scanner 101 does not add a timestamp to the document. Alternatively, digital scanner 101 adds a tag to the digital document indicating that the timestamp information source was not verified at the time the digital document was generated.

At step 204, a cyclic redundancy check (CRC) is generated in a well-known manner for the digital document by, for example, digital signature generator 114 or a cyclic redundancy check generator (not shown). Alternatively, a one-way hash function of scanned document 114 could be generated in a well-known manner. At step 205, digital signature generator 115 generates an encrypted string, or digital signature, by using private key 116 to encrypt the timestamp obtained when the digital document was generated and the CRC for the digital document. Alternatively, the encrypted string can include the timestamp information obtained when the digital document was generated, the CRC for the digital document and the results of a tracert command and/or the digital certificate for the time source. As yet another alternative, digital signature generator 115 could encrypt the entire scanned document and the timestamp information using private key 114 of the key pair.

At step 206, the digital signature is attached to the digital document as, for example, a tag in a TIFF-formatted file or as a property in a PDF-formatted file. At step 207, public key 117 is attached to the digital document as a separate tag when the digital document is in a TIFF-type format and as a property when the digital document is in a PDF-type format. Alternatively, public key 117 is made available, such as by a response to a request for public key 117 received by digital scanner 101 from a telecommunications network, for later verifying the timestamp and/or CRC of a scanned document. As yet another alternative, digital scanner 101 could provide an html-based resource for managing the public/private keys used by digital scanner 101 and for making the public keys available.

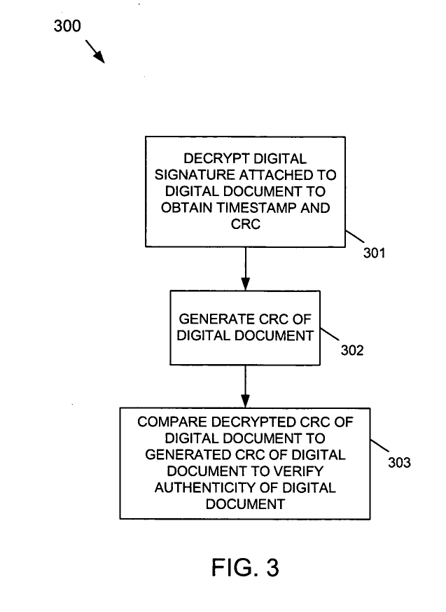

FIG. 3 shows a flow diagram 300 of a method according to the present invention verifying the time of existence of a digital document. At step 301, the encrypted string attached to a digital document is decrypted using public key 117 that is also attached to the digital document to obtain the timestamp and the CRC (and the tracert list information, if included) that was generated for the digital document was generated. Alternatively, public key 117 can be obtain from scanner 101. At step 302, the CRC (or one-way hash function) of the digital document is generated. At step 303, the decrypted CRC and the recently generated CRC are compared to verify the authenticity of the digital document. When the digital document has been modified, the decrypted CRC contained in the digital signature will not match the CRC generated for the digital document.

Once the digital copy of document 114 has been generated and the digital signature has been attached to the digital document, the digital document and digital signature can be stored in a memory (not shown) of scanner 101 in a well-known manner. Alternatively, the digital document and digital signature for the digital document can be stored in a well-known manner on, for example, a floppy disk, a compact disc (CD) and zip drive, a smart card and/or be transmitted to another memory and/or device coupled to either of first telecommunications network 102 or second telecommunications network 103.

An alternative embodiment of the present invention provides that digital scanner 101 stores a plurality of public/private key pairs, with each key pair corresponding to, for example, each user that generates a digital document,

While the methods depicted herein as a sequence of numbered steps for clarity, no order should be inferred from the numbering unless explicitly stated. It should be understood that some of the steps may be skipped, performed in parallel, or performed without the requirement of maintaining a strict order of sequence.

Although the foregoing invention has been described in some detail for purposes of clarity of understanding, it will be apparent that certain changes and modifications may be practiced that are within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A system for associating a timestamp with a digital document, the system comprising:
a digital document generator generating a digital document; and
a digital signature generator generating a digital signature for the digital document by encrypting a time obtained from a time source with a private key of a public/private key pair, the time being obtained from the time source when the digital document is generated and the time source being traceable to a time standard.

2. The system according to claim 1, wherein the time source is a Network Time Protocol (NTP) server.

3. The system according to claim 1, wherein the time source is a National Institute of Standards and Technology (NIST) time server.

4. The system according to claim 1, wherein the time source is a radio broadcast station.

5. The system according to claim 1, wherein the digital document generator is one of a digital scanner, a printer, a facsimile machine, a copier, a multifunctional peripheral (MFP) device, a digital camera, a mobile telephone having a digital camera, and a personal computer (PC).

6. The system according to claim 1, wherein the digital document generator generates a TIFF-formatted digital document, and
wherein the digital signature generator attaches the digital signature to the digital document as a tag.

7. The system according to claim 1, wherein the digital document generator generates a PDF-formatted digital document, and wherein the digital signature generator attaching the digital signature to the digital document as a property of the digital document.

8. The system according to claim 1, wherein the digital document generator generates a digital image-based document.

9. The system according to claim 1, wherein the digital document generator generates an electronically editable document.

10. The system according to claim 1, further comprising a cyclic redundancy check generator generating a cyclic redundancy check value for the digital document; and
wherein the digital signature generator generates the digital signature by encrypting the time obtained from the time source and the cyclic redundancy check value with the private key.

11. The system according to claim 1, further comprising a one-way hash function generator generating a one-way hash function for the digital document; and
wherein the digital signature generator generates the digital signature by encrypting the time obtained from the time source and the one-way hash function with the private key.

12. The system according to claim 1, wherein the digital signature generator attaches a public key of the public/private key pair to the digital document.

13. The system according to claim 12, further comprising a cyclic redundancy check generator generating a cyclic redundancy check value for the digital document; and
wherein the digital signature generator generates the digital signature by encrypting the time obtained from the time source and the cyclic redundancy check value with the private key.

14. The system according to claim 12, further comprising a one-way hash function generating a one-way hash function for the digital document; and
wherein the digital signature generator generates the digital signature by encrypting the time obtained from the time source and the one-way hash function with the private key.

15. A method for associating a timestamp with a digital document, the method comprising:
generating a digital document;
obtaining a time from a time source that is traceable to a time standard when the digital document is generated; and
generating a digital signature for the digital document by encrypting the time obtained from the time source with a private key of a public/private key pair.

16. The method according to claim 15, wherein obtaining the time includes obtaining the time from a Network Time Protocol (NTP) server over a telecommunications network.

17. The method according to claim 15, wherein obtaining the time includes obtaining the time from a National Institute of Standards and Technology (NIST) time server over a telecommunications network.

18. The method according to claim 15, wherein obtaining the time includes obtaining the time from a radio broadcast station.

19. The method according to claim 15, wherein generating the digital document generates the digital document generator by one of a digital scanner, a printer, a facsimile machine, a copier, a multifunctional peripheral (MFP) device, a digital camera, a mobile telephone having a digital camera, and a personal computer (PC).

20. The method according to claim 15, wherein the digital document is a TIFF-formatted file, the method further comprising attaching the digital signature to the digital document as a tag.

21. The method according to claim 15, wherein the digital document is a PDF-formatted file, the method further comprising attaching the digital signature to the digital document as a property of the digital document.

22. The method according to claim 15, wherein the digital document is a digital image-based document.

23. The method according to claim 15, wherein the digital document is an electronically editable document.

24. The method according to claim 15, further comprising generating a cyclic redundancy check value for the digital document; and
wherein generating the digital signature includes encrypting the time obtained from the time source and the cyclic redundancy check value with the private key.

25. The method according to claim 15, further comprising generating a one-way hash function for the digital document; and
wherein generating the digital signature includes encrypting the time obtained from the time source and the one-way hash function with the private key.

26. The method according to claim 15, further comprising attaching a public key of the public/private key pair to the digital document.

27. The method according to claim 26, further comprising generating a cyclic redundancy check value for the digital document; and
wherein generating the digital signature includes encrypting the time obtained from the time source and the cyclic redundancy check value with the private key.

28. The method according to claim 26, further comprising generating a one-way hash function for the digital document; and
wherein generating the digital signature includes encrypting the time obtained from the time source and the one-way hash function with the private key.

29. The method according to claim 15, further comprising decrypting the digital signature using a public key of the public/private key pair.
